(19) United States
(12) Patent Application Publication
(10) Pub. No.: US 2003/0078982 A1
(43) Pub. Date: Apr. 24, 2003

(54) Electronic mail transmission apparatus and method

(75) Inventor: Hidehiko Ogawa, Tokyo (JP)

Correspondence Address: GREENBLUM & BERNSTEIN, P.L.C., 1950 ROLAND CLARKE PLACE, RESTON, VA, 20191, US

(73) Assignee: Matsushita Graphic Communication Systems, Inc., Tokyo (JP)

(21) Appl. No.: 10/245,320

(22) Filed: Sep. 18, 2002

(30) Foreign Application Priority Data
Oct. 19, 2001 (JP) 2001-321635

(51) Int. Cl. G06F 15/16

(52) U.S. Cl. 709/206; 709/246

(57) ABSTRACT

Transmission data is generated through a conversion process in which character string data attached to e-mail is matched with a character set type that can be processed by a destination terminal apparatus. In addition, character string data of set phrases that are generated by using character sets that are standard in each plurality of language types is stored in a language-based set phrase memory. By selecting a set phrase registered in the language-based set phrase memory, based on a language type that is set by the destination terminal apparatus, transmission data is generated in accordance with the character string data. Capability information in relation to a character set type and language type is either obtained from MDN data within a response mail to be stored in an address-based terminal capability memory, or obtained via a communication process in accordance with an ESMTP step.

### BACKGROUND OF THE INVENTION

1. Field of the Invention

The invention relates to an electronic mail transmission apparatus and method, specifically, an apparatus and method in which electronic mail data is transmitted in an appropriate format to destination terminals based on capability information pertaining to each destination terminals.

2. Description of Related Art

An increasing number of e-mail transmission apparatuses having electronic mail (hereafter referred to as “e-mail”) transmission/reception functions, such as personal computers and cell phones, are available in the market. When these apparatuses are employed to transmit e-mail messages, a predetermined character string is input through a keyboard, character string data is generated from a preset character set (Charset), and the data is stored in a predetermined field to created e-mail data.

Moreover, operation of the e-mail function can become more convenient by preregistering set phrases used for e-mail in an apparatus, thus relieving the operator from manually inputting individual characters. For example, an Internet facsimile apparatus employs a method of transmitting document image data via e-mail, where the image data is transmitted with a subject frame having a set phrase stating that it is a facsimile image, so that the receiver can immediately recognize that the receiving e-mail is a facsimile image. It is also convenient to provide a cell phone with a capability to select set phrases indicating required messages, since it is cumbersome to input characters using cell phones.

The above-described character sets, which are pre-registered in an apparatus, are not shared by all e-mail transmission apparatuses, and character sets used by a transmitting apparatus may not necessarily be handled by the receiving apparatus. If the receiving apparatus receives an incompatible character set, it will not be able to appropriately display and record characters, creating so-called an indecipherable garbling (meaningless group of characters).

It is general practice that the above-described set phrases are displayed using the pre-registered character sets in the language native to the country where the apparatus is used. As a result, an e-mail message sent to a destination having a different language, e.g., a message is sent to another country, will render the set phrase attached to the e-mail message indecipherable for the receiver. For example, when sending an e-mail message having a set phrase in Japanese to the USA from Japan, many American will consider the phrase indecipherable; therefore, the message fails to be understood by the receiver.

### SUMMARY OF THE INVENTION

The present invention is provided to address the above-described problem. The first object of the invention is to provide an e-mail transmission apparatus and method that is able to prevent a garbling at receiving terminals. The second object of the invention is to provide an e-mail transmission apparatus and method that is able to transmit a set phrase displayed in a language understood by the receiver.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a block diagram illustrating a schematic configuration of an Internet facsimile apparatus to which the present invention is applied;

FIG. 2 illustrates a destination-based terminal capability registration table that is stored in a destination-based terminal capability memory of FIG. 1;

FIG. 3 illustrates a language-based set phrase registration table that is stored in a language-based set phrase memory of FIG. 1;

FIG. 4 is a flowchart illustrating a transmission data generation process in CPU of FIG. 1;

FIG. 5 illustrates a sequence of MDN transmission/reception;

FIG. 6 illustrates an example of a response to mail including an MDN request;

FIG. 7 is a sequence chart illustrating a procedure of ESMTP;

FIG. 8 is a flowchart illustrating a sequence of document transmission process of the facsimile apparatus of FIG. 1;

FIG. 9 is a flowchart illustrating a sequence of MDN reception process of the facsimile apparatus of FIG. 1;

FIG. 10 is a flowchart illustrating a sequence of transmission data generation process shown in FIG. 8; and

FIG. 11 is a flowchart illustrating a continued sequence from connectors 1 and 2 shown in FIG. 10.

### DETAILED DESCRIPTION OF PREFERRED EMBODIMENTS

The embodiment of the present invention is explained in the following, in reference to the above-described drawings.

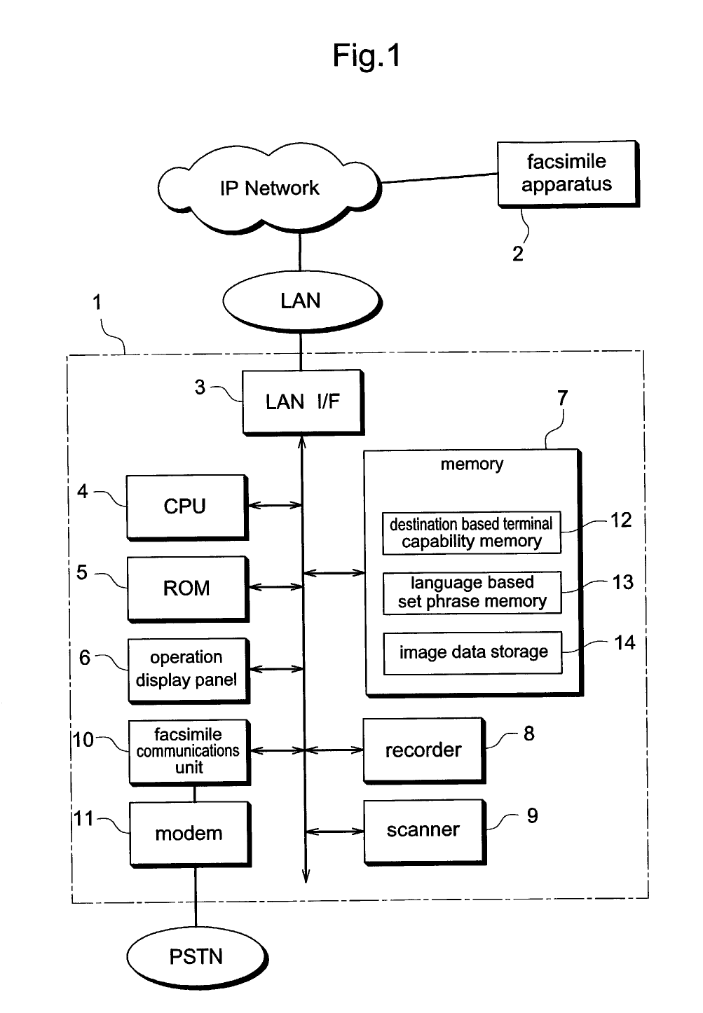

FIG. 1 is a block diagram illustrating a schematic configuration of an Internet facsimile apparatus to which the present invention is applied. Facsimile apparatus 1 is connected to an IP network via LAN, thus forming a system that allows facsimile apparatus 1 to exchange image data with other facsimile apparatus 2, using the e-mail method. Facsimile apparatus 1 is provided with LAN interface 3 to be connected to LAN, CPU (control unit) 4 that controls the operation of the entire apparatus, ROM 5 that stores programs needed for the operation of CPU 4, operation display panel 6 that directs the operation of the apparatus and displays status of the apparatus, memory 7 that stores apparatus setup information and image data, recorder 8 that records received image data on a recording paper, and scanner 9 that scans transmitted document through an image sensor. Moreover, facsimile apparatus 1 is connected to PSTN via facsimile communication unit 10 and modem 11, thereby allowing image exchanges of Group 3 facsimile communication procedure.

Memory 7 includes destination-based terminal capability memory 12 that stores a plurality of terminal capability information for each destination in relation to destination identification information, language-based set phrase memory 13 that stores character string data of a set phrase attached to e-mail message in relation to a language type with which the data is displayed, and image data storage 14 that temporality stores reception image data and scanned image data. Destination-based terminal capability memory 12 stores character set types that can be processed by each terminal apparatus, and language types set for each terminal apparatus as terminal capability information. Character string data of set phrases that is stored in language-based set phrase memory 13 is generated by employing standard character set given to each language type.

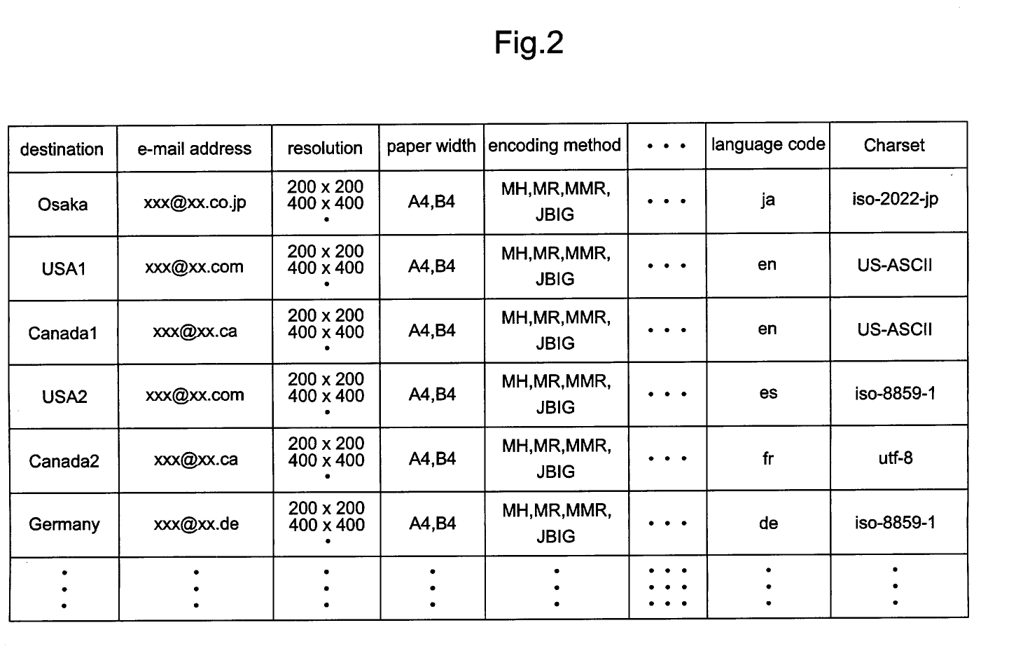

FIG. 2 shows an example of the destination-based terminal capability registration table that is stored in destination-based terminal capability memory 12 of FIG. 1. The destination-based terminal capability registration table registers information such as language type (language code), character set type (Charset), resolution, paper width, and encoding method, in association with destination name and e-mail address (destination identification information). The language codes are stored according to ISO639-1 (Alpha-2code) that specifies “ja” for Japanese, “en” for English, “es” for Spanish, “fr” for French, and “de” Germany.

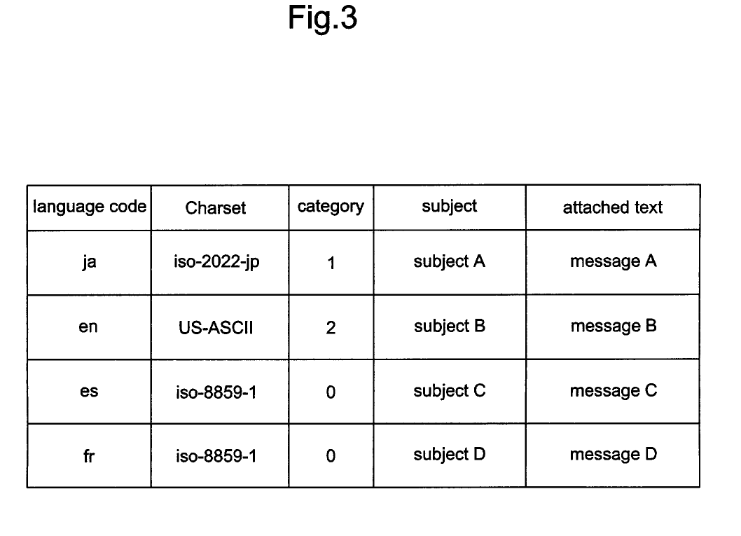

FIG. 3 shows an example of the language-based set phrase registration table that is stored in language-based set phrase memory 13 of FIG. 1. The language-based set phrase registration table registers standard character set type (Charset) for each language type (language code), set phrases generated by employing the standard character set for each language type; i.e., set phrases for subjects (subjects A-D) to be written in a subject field that comprises an e-mail header, and set phrases for attached texts (messages A-D) to be included in the body of an e-mail message along with image data. This registration table also registers categories for each combination of language and standard character set, wherein “1” is specified for a combination of default language and the character set while “2” is specified for a combination of multi-use language and the character set.

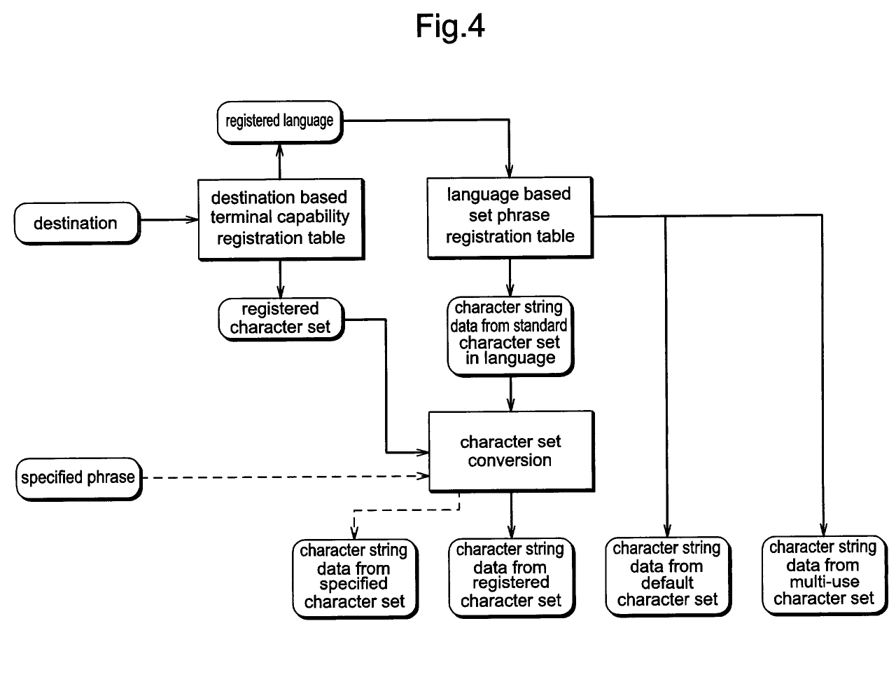

FIG. 4 is a flowchart illustrating a transmission data generation process in CPU (transmission data generation unit) 4 of FIG. 1. CPU 4 selects a set phrase registered in the language-based set phrase registration table, based on the language type of the destination, which is registered in the destination-based terminal capability registration table, and then generates transmission data based on character string data of the set phrase. When the destination character set type registered in the destination-based terminal capability table does not match with standard character set type for the language type of the destination, transmission data is generated after a conversion process, wherein the character string data of the set phrase that is selected based on the language type of the destination is converted into the destination character set type registered in the destination-based terminal capability registration table.

The above process is further explained with situational examples. When a certain destination language type and character set type is registered in the destination-based terminal capability table, and when the language-based set phrase registration table has data corresponding to the registered language of the destination, the corresponding character string data from the standard character set in the language is used “as is”. Conversely, when a registered character set of a destination is different from the standard character set in the language, the character string data is converted into the registered character set. When the conversion to the registered character set is not possible, character string data from the multi-use character set (US-ASCII) is applied. When there is no corresponding data for the registered language for the destination in the language-based set phrase registration table, the character string data from the multi-use character set is used.

When a language type and character set type of a certain address is unknown, i.e., the certain address is not registered in the destination-based terminal capability table, or when the language type and character set type is not registered even though the address is registered, character string data written with a preset default character set is used.

Moreover, when the operator specifies a phrase for the subject during a transmission, i.e., when the operator selects a specific set phrase within the pre-registered phrases or manually inputs an appropriate phrase, the conversion into a character set of the registered destination is performed, if it is possible. If the conversion is not possible, the character string data specified by the operator is used “as is”.

Hereafter, the outline of the transmission data generation process that is performed by the above-described CPU 4 is explained using the example of FIGS. 2 and 3. The destinations, Osaka, USA 1 and 2, and Canada 1, in the destination-based terminal capability registration table of FIG. 2, have corresponding language codes in the language-based set phrase registration table of FIG. 3, and match with the character set registered in the destination-based terminal capability registration table. Therefore, the corresponding character string data (subjects A-C, messages A-C) in the language-based set phrase registration table is used “as is”.

The destination, Canada 2, in the destination-based terminal capability registration table, has a corresponding language code (fr) in the language-based set phrase registration table, however the character sets do not match. Therefore, character string data (subject D and message D) written in the standard character set (iso-8859-1) in French, which is registered in the language-based set phrase registration table, is converted into the character set registered in the destination-based terminal capability registration table (utf-8).

The destination, Germany, in the destination-based terminal capability registration table, does not have the corresponding language code (de) in the language-based set phrase registration table. Therefore, character string data (subject B and message B) written in the multi-purpose language code (en) specified in category 2 and in the character set (US-ASCII) is used. When the capability information of the destination terminal is unknown because the destination is not registered in the destination-based terminal capability registration table or because of other reasons, character string data (subject A and message A) written in the default language code (ja) specified in category 1 and in the character set (iso-2022-jp) is used.

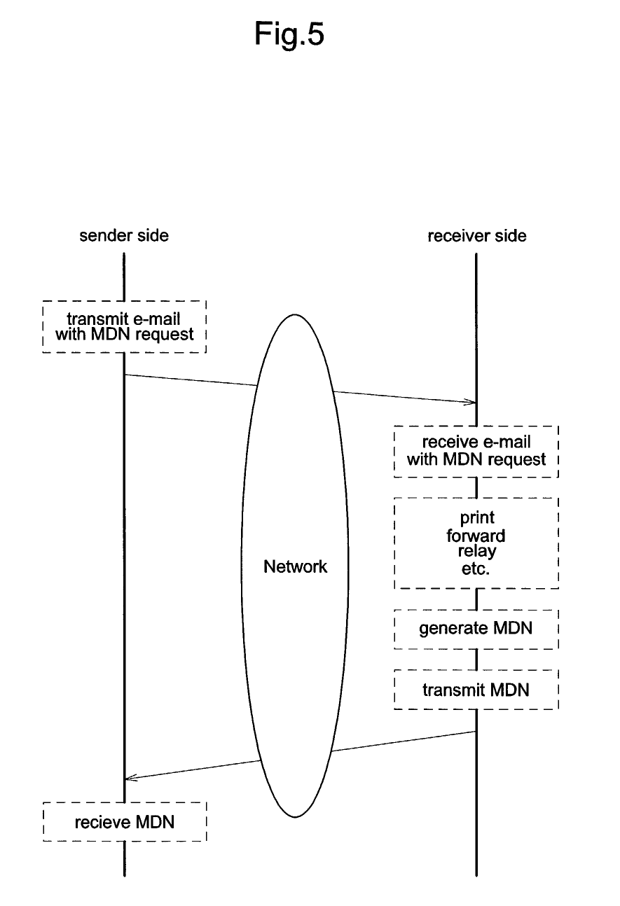

FIG. 5 illustrates a sequence of MDN transmission/reception that obtains destination terminal capability information. First, the sender apparatus (facsimile apparatus 1) generates header information including MDN requesting information, as well as main body content by converting the transmission image data using MIME, and transmits the obtained e-mail data with an MDN request. When the receiver apparatus (facsimile apparatus 2) receives the e-mail data with the MDN request, necessary processes such as printing, forwarding and relaying are performed. Also, when the receiver apparatus is compliant with MDN and has a setting to include its capability information in the MDN, the receiver apparatus reads out the capability information stored in its apparatus, generates MDN data set in a predetermined field, and transmits the MDN to the reply destination (sender apparatus) that is specified in the MDN request information. Upon receiving the MDN, the sender apparatus retrieves the capability information of the receiver side from the MDN data, and registers the data in the destination-based terminal capability registration table in the destination-based terminal capability memory. Since MDN requests are always transmitted along with e-mail messages, it is possible to obtain the capability information at every e-mail transmission and to update the registration content, in order to provide a process based on the newest capability information. Similar MDN procedure is performed for regular e-mail transmission in order to notify the receiver's processing result, however, it is possible to also obtain capability information by presetting the receiver apparatus so as to notify its capability information along with the processing result.

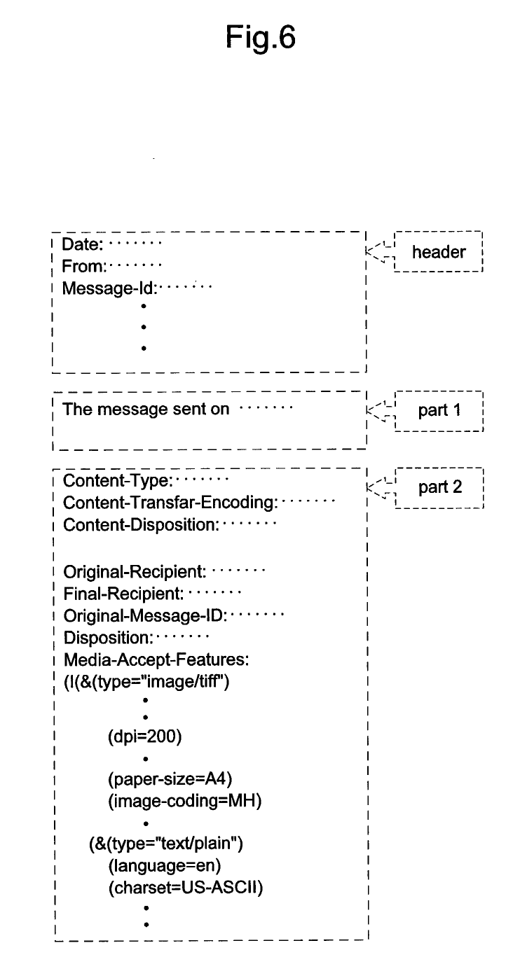

FIG. 6 illustrates an example of a response to mail including an MDN request. The header section includes transmission date (Date), sender of the notification mail (From), message ID (Message-ID), etc. Part 1 of the body lists a message that the e-mail has been delivered, so that the receiver of the MDN can view the message. Part 2 of the body includes content type (Content-Type), content encoding method (Content-Transfer-Encoding), content display format (Content-Disposition), mail address of the notification mail (Original-Recipient), final receiver (Final-Recipient), message ID of the notification mail (Original-Message-ID), process content (Disposition), and capability information (Media-Accept-Features). The Media-Accept-Features includes resolution (dpi=200), paper width (paper-size=A4), encoding method (image-coding=MH), language code (language=en), and character set (charset=US-ASCII).

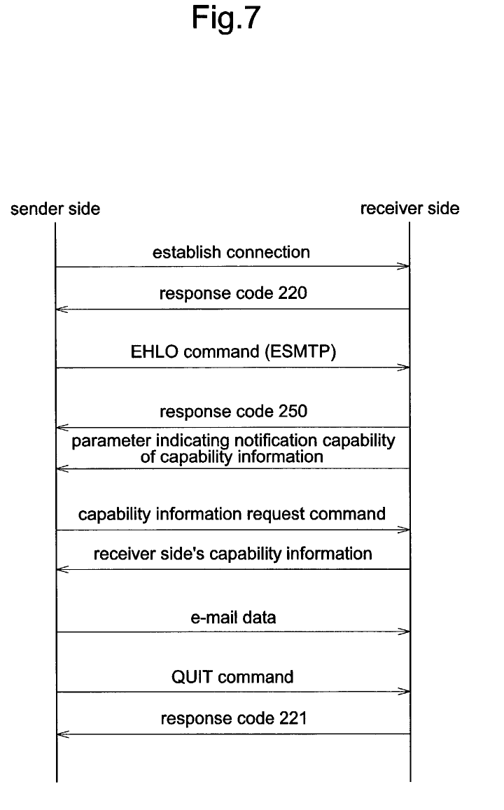

FIG. 7 is a sequence chart illustrating a procedure of ESMTP that obtains terminal capability information of the destination. Sender apparatus (facsimile apparatus 1) establishes a TCP connection with the receiver apparatus (facsimile apparatus 2). When the receiver apparatus sends a response code 220 indicating that it is ready for a command request, the sender apparatus transmits an EHLO command to make a transition to the ESMTP mode. When the receiver apparatus sends a response code 250 indicating that the status is normal, and a parameter indicating the notification capability of the capability information, the sender apparatus transmits a capability information request command. Then the receiver apparatus informs a parameter indicating the content of its capability information. Accordingly, the sender apparatus can obtain the language type and character set information of the receiver apparatus and generate e-mail data and transmit the same to the receiver apparatus according to the obtained information. Then, a QUIT command from the sender apparatus and response code 221 from the receiver apparatus are exchanged, to terminate the connection.

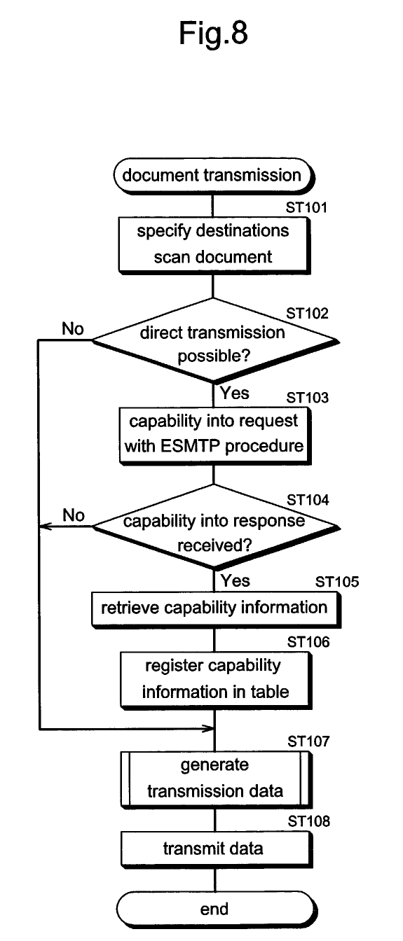

FIG. 8 is a flowchart illustrating a sequence of document transmission process of the facsimile apparatus of FIG. 1. When performing a direct transmission to the receiver apparatus by obtaining an IP address and bypassing the mail server, receiver apparatus's capability information is obtained according to the procedure of ESMTP prior to transmitting the e-mail data, so that e-mail data is generated based on the information. Conversely, when performing a normal e-mail transmission via mail server, e-mail data is generated based on the registered capability information, if the capability information is already registered.

At step 101, operator specifies a destination, and the document is scanned. Then, it is determined whether a direct transmission is possible at step 102. Specifically, it is determined whether the direct transmission is possible based on the domain name of the transmission destination. By pre-registering data indicating whether a direct transmission is possible, a determination can be also made based on such data. When the direct transmission is possible, capability information is requested using ESMTP procedure shown in FIG. 7 at step 103. When a response regarding the capability information is received at step 104, capability information is retrieved from the reception data at step 105. Then, the obtained capability information is associated with the corresponding destination and registered in the destination-based terminal capability registration table shown in FIG. 2 at step 106, and the control proceeds to step 107.

At step 107, capability information is read out from the destination-based terminal capability registration table to generate transmission data. Then, e-mail data is transmitted at step 108. When it is determined that the direct transmission is impossible at step 102, or when there is no response regarding the capability information at step 104, the control proceeds to step 107. Since the transmission data generation process at step 107 obtains capability information using an MDN as explained later, its own mail address is specified in a predetermined field (Disposition-Notification-To: in the header) in the transmitting e-mail in order to request an MDN.

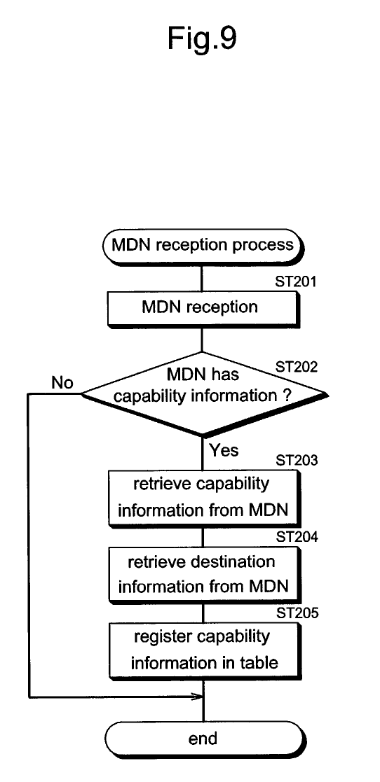

FIG. 9 is a flowchart illustrating a sequence of MDN reception process of the facsimile apparatus 1 of FIG. 1. In this stage, CPU 4 retrieves destination and capability information from the received MDN to register the information in the destination-based capability registration table shown in FIG. 2.

When an MDN is received at step 201, it is determined whether the MDN has capability information at step 202. When the MDN has capability information, the control proceeds to step 203 in order to retrieve the capability information from the MDN. Also, the destination information is retrieved from the MDN at step 204, in order to search the destination terminal capability registration table based on the destination information. At step 205, the obtained capability information is registered in the destination-based terminal capability registration table in association with the corresponding destination. An e-mail address listed in the header of an MDN can be used for the destination information that is retrieved from MDN at step 204. However, fields such as e-mail address of the body (Original-Recipient), final recipient (Final-Recipient), or message ID (Original-Message-ID) can be used as the destination information.

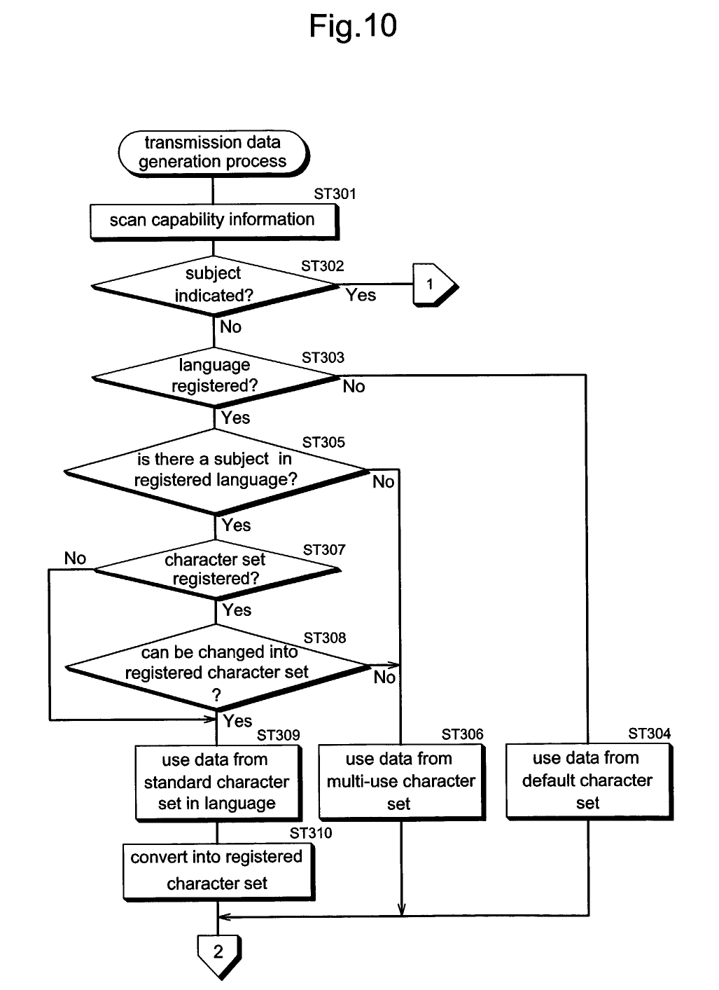

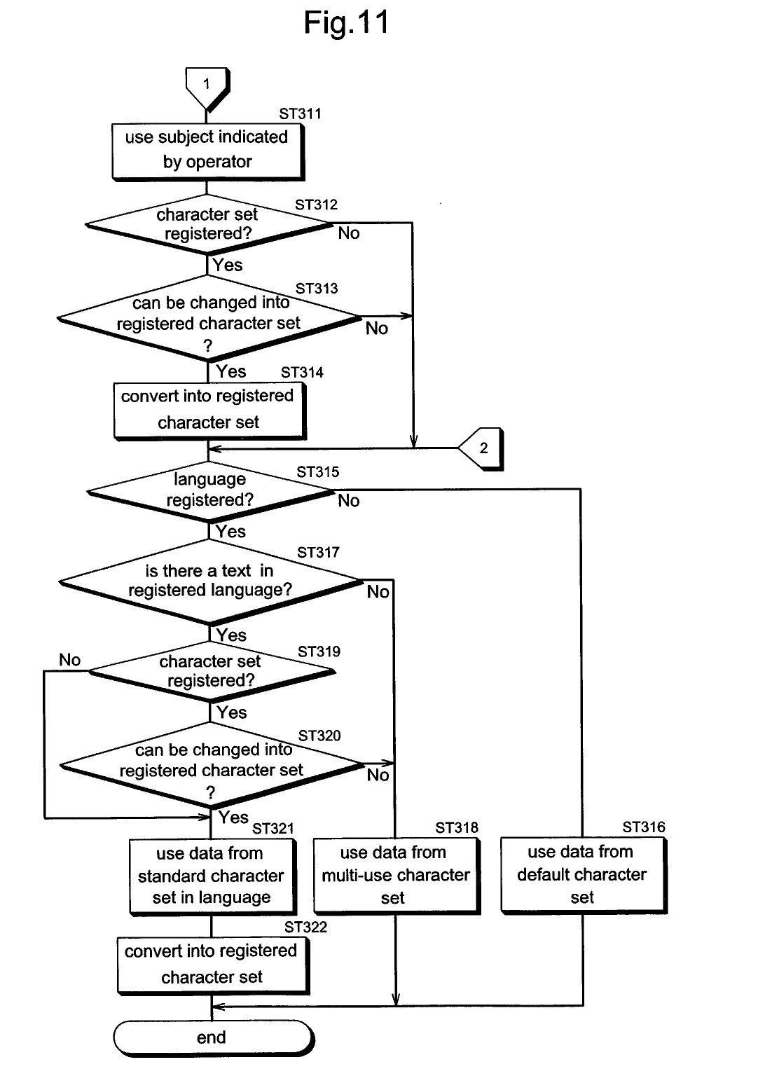

FIG. 10 is a flowchart illustrating a detailed sequence of transmission data generation process shown in step 107 of FIG. 8. In this embodiment, capability information is first retrieved from the destination-based terminal capability registration table at step 301, and whether the operator has specified a phrase for subject is checked at step 302. When the operator has specified a phrase, the control proceeds to a data conversion process of subject character string that starts at step 311 of FIG. 11. When the operator has not specified a phrase, the control proceeds to step 303.

At Step 303, it is checked whether the language type for the corresponding destination is registered in the destination-based terminal capability registration table. When the language type is not registered, the control proceeds to step 304, and character string data for the subject set phrase (subject A) according to the default character set of category 1 (iso-2022-jp) is used. When the language type for the corresponding destination is registered, conversely, the control proceeds to step 305 to check whether a subject set phrase corresponding to the registered language is registered in the language-based set phrase registration table. When there is a subject set phrase of the registered language, the control proceeds to step 307. When there is no subject set phrase of the registered language, the control proceeds to step 306 to use character string data (subject B) according to the multi-use character set of category 2 (US-ASCII).

Step 307 checks whether the character set type for the corresponding address is registered in the destination-based terminal capability registration table. When the character set type is registered, the control proceeds to step 308 to check whether a conversion process into the registered character set is possible. When the conversion process into the registered character cannot be done, the control proceeds to step 306 to use the character string data of the multi-use character set.

When it is determined that conversion into the registered character set is possible at step 308, the control proceeds to step 309 to use the character string data of the standard character set in the language. Then, the character string data is converted into the registered character set at step 310. In addition, when it is determined that the character set type is not registered at step 307, character string data of the standard character set in the language is used. However, the character set is not converted. Accordingly, when the subject set phrase is selected and the character string data is converted, the control proceeds to step 315 of FIG. 11 for an attached text processing.

FIG. 11 is a flowchart illustrating the sequences of connectors 1 and 2 of FIG. 10. In this drawing, when an operator specifies a subject phrase, the character string data is converted into a character set that is registered in the destination-based terminal capability registration table. When the conversion into the registered character set is not possible, the character string data that is input by the operator is used “as is”. Also, in a similar sequence as the process of setting the character string data for subject shown in FIG. 10, character string data for attached text is set.

When it is determined that the operator specified the subject phrase at step 302, the character string specified by the operator is used at step 311. Then, it is checked whether the character set is registered in the destination-based terminal capability registration table at step 312. When the character set is registered, the control proceeds to step 313 to check whether the character string data can be converted into the registered character set. When it can be converted, the control proceeds to step 314 to convert the character string data of the subject phrase into the character set of the destination. Then, the control proceeds to the setting process of the character string data of the attached text that starts from step 315. When the character set is not registered at step 312, or when the conversion into the registered character set is not possible at step 313, the conversion into the registered character set is not performed. When the conversion into the registered character set is not possible, character string data of the multi-use character set (US-ASCII) may be used.

At step 315, it is checked whether the language type for the corresponding address is registered in the destination-based terminal capability registration table. When the language type is not registered, the control proceeds to step 316 to use the character string data (message A) of the attached text set phrase according to the category 1 default character set (iso-2022-jp). When the language type for the corresponding destination is registered, the control proceeds to step 317 to determine whether the attached text set phrase that corresponds to the registered language is in the language-based set phrase registration table. When the attached text set phrase for the registered language is found, the control proceeds to step 319. When the attached text set phrase for the registered language is not found, the control proceeds to step 318 to use the character string data (message B) according to the category 2 multi-use character set (US-ASCII).

At step 319, it is checked whether the character set type for the corresponding destination is registered in the destination-based terminal capability registration table. When the character set type is registered, the control proceeds to step 320 to determine whether the conversion into a registered character set is possible. When it is determined that the conversion into the registered character set is not possible, the control proceeds to step 318 to use the character string data according to the multi-use character set.

When it is determined that the conversion into the registered character set is possible at step 320, the control proceeds to step 321 to use the character string data of the character set that is standard to the language. Then, the character string data is converted into the registered character set at step 322. When it is determined that the character set type is not registered at step 319, the character string data of the standard character set according to the corresponding language type is used; however, the character set conversion is not performed.

In this embodiment, character set conversion is performed on set phrases used for subjects and attached texts as well as phrases input as subjects. However, this invention is not limited to the above embodiment, and can be used for various character string data for transmission processing. For example, a normal G3 facsimile apparatus can transmit sender information at a top end of a transmitting image. When the sender apparatus generates such character string data indicating the sender information by referring to the receiver facsimile apparatus's capability information and matching the character string data with the receiver apparatus, the receiver can appropriately process the sender information. In addition, when the character string data for the phrase listed on the cover page of the transmitting document is generated to match the receiver apparatus, the receiver can receive a cover page that is easy to understand. Further, similar process can be applied to generating transmission data for e-mail messages that provide various information periodically or under a predetermined condition, in the forms of transmission journal, service information, report, etc.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above-described embodiments, and various variations and modifications may be possible without departing from the scope of the present invention.

This application is based on the Japanese Patent Application No.2001-321635 filed on Oct. 19, 2001, entire content of which is expressly incorporated by reference herein.

What is claimed is:

1. An e-mail transmission apparatus comprising:
a designator that designates a character set type;
a converter that converts transmission character data into character string data of the character set type designated by said designator; and
a transmitter that transmits the converted character string data by e-mail.

2. An e-mail transmission apparatus comprising:
a memory configured to stores a plurality of destinations and a plurality of character set types, each destination being stored in said memory, in association with each character set type, respectively;
a converter that converts transmission character data into character string data of a character set type corresponding to a designated destination; and
a transmitter that transmits the converted character string data by e-mail.

3. An e-mail transmission apparatus comprising:
a memory configured to stores a plurality of language types and a plurality of set phrases, each language type being stored in said memory, in association with each set phrase, respectively;
a designator that designates a language type;
a generator that extracts a set phrase corresponding to the language type designated by said designator, and generates transmission data, using the extracted the set phrase; and
a transmitter that transmit the generated transmission data.

4. The e-mail transmission apparatus according to claim 3, wherein said generator selects a predetermined language type stored in said memory when there is not the language type designated by said designator in said memory, and generates transmission data, using a phrase set corresponding to the predetermined language type.

5. The e-mail transmission apparatus according to claim 3, wherein the set phrase is written in a main body of the e-mail.

6. The e-mail transmission apparatus according to claim 3, wherein the set phrase is written in a subject frame of the e-mail.

7. The e-mail transmission apparatus according to claim 3, further comprising a memory a plurality of language types and a plurality of destination addresses, each language type being stored in association with each destination address, respectively,
wherein a language type in said memory is selected by designating destination address.

8. The e-mail transmission apparatus according to claim 2, further comprising:
a destination-based terminal capability memory that stores terminal capability information in association with a destination address, the information including at least one of character set type that can be processed by a destination terminal apparatus and/or language type that is set by the destination terminal apparatus.

9. The e-mail transmission apparatus according to claim 8, further comprising:
a controller that obtains the terminal capability information from MDN data within response mail, the mail being transmitted from the destination terminal apparatus according to an MDN request attached to e-mail data, and registers the information in the destination-based terminal capability memory.

10. The e-mail transmission apparatus of claim 3, wherein terminal capability information, which includes at least one of character set type that can be processed by the destination terminal apparatus and/or language type that is set by the destination terminal apparatus, is obtained according to a transmission procedure in accordance with an ESMTP process.

11. A method for an e-mail transmission, the method comprising:
designating a character set type;
converting transmission character data into character string data of the character set type designated; and
transmitting the converted character string data by e-mail.

12. A method for an e-mail transmission, using a memory configured to stores a plurality of destinations and a plurality of character set types, each destination being stored in said memory, in association with each character set type, the method comprising:
converting transmission character data into character string data of a character set type corresponding to a designated destination; and
transmitting the converted character string data by e-mail.

13. A method for an e-mail transmission, using a memory configured to stores a plurality of language types and a plurality of set phrases, each language type being stored in said memory, in association with each set phrase, the method comprising:
designating a language type;
extracting a set phrase corresponding to the language type designated;
generating transmission data, using the extracted the set phrase; and
transmitting the generated transmission data.
